(19) United States
(12) Patent Application Publication
(10) Pub. No.: US 2021/0163334 A1
(43) Pub. Date: Jun. 3, 2021

(54) METHODS AND APPARATUS FOR MANUFACTURING A GLASS RIBBON

(71) Applicant: Corning Incorporated, Corning, NY (US)

(72) Inventors: James William Brown, Painted Post, NY (US); Nicholas Dominic Cavallaro, III, Corning, NY (US); Dean George Sakona, Corning, NY (US); Jeremy Yaldo, Belle River (CA); Naiyue Zhou, Painted Post, NY (US)

(21) Appl. No.: 17/268,005

(22) PCT Filed: Aug. 5, 2019
(86) PCT No.: PCT/US2019/045114

§ 371 Date: Feb. 11, 2021

Related U.S. Application Data
(60) Provisional application No. 62/718,664, filed on Aug. 14, 2018.

(51) Int. Cl. C03B 17/06; B65G 49/06

(52) U.S. Cl. CPC C03B 17/068; B65G 49/061; B65G 49/066; C03B 17/064

(57) ABSTRACT

A glass manufacturing apparatus includes a glass ribbon gripping device including a first column of jaw clamps spaced from one another along a first clamp path extending in a glass ribbon travel direction of the glass manufacturing apparatus. The glass manufacturing apparatus includes a second column of jaw clamps spaced from one another along a second clamp path extending in the glass ribbon travel direction of the glass manufacturing apparatus. The first column of jaw clamps and the second column of jaw clamps are spaced apart in a lateral direction perpendicular to the glass ribbon travel direction. Additionally, methods of manufacturing a glass ribbon with the glass manufacturing apparatus are provided.

This application claims the benefit of priority under 35 U.S.C. § 119 of U.S. Provisional Application Ser. No. 62/718,664, filed on Aug. 14, 2018, the content of which is relied upon and incorporated herein by reference in its entirety.

### FIELD

The present disclosure relates generally to methods and apparatus for gripping a glass ribbon and, more particularly, to methods of gripping a glass ribbon with a glass ribbon gripping device comprising one or more jaw clamps.

### BACKGROUND

It is known to grip a glass ribbon with a vacuum cup during a fusion forming process of the glass ribbon. Slippage between the vacuum cup and the glass ribbon is possible due to the heat of the glass ribbon. In addition, this heat may lead to a shortened lifespan of the vacuum cup, thus increasing costs due to repair or replacement of the vacuum cup.

### SUMMARY

The following presents a simplified summary of the disclosure to provide a basic understanding of some embodiments described in the detailed description.

In accordance with some embodiments, a glass manufacturing apparatus can comprise a glass ribbon gripping device comprising a first column of jaw clamps spaced from one another along a first clamp path extending in a glass ribbon travel direction of the glass manufacturing apparatus. The glass ribbon gripping device can comprise a second column of jaw clamps spaced from one another along a second clamp path extending in the glass ribbon travel direction of the glass manufacturing apparatus. The first column of jaw clamps and the second column of jaw clamps can be spaced apart in a lateral direction perpendicular to the glass ribbon travel direction.

In one embodiment, the glass manufacturing apparatus can further comprise a support surface positioned below at least one of the first column of jaw clamps and the second column of jaw clamps. The support surface can extend at least partially across a travel path of the glass ribbon.

In another embodiment, at least one jaw clamp of the first column of jaw clamps can be laterally adjustable in the lateral direction relative to at least one jaw clamp of the second column of jaw clamps.

In another embodiment, at least one jaw clamp of the first column of jaw clamps can be vertically adjustable in the glass ribbon travel direction relative to at least one jaw clamp of the second column of jaw clamps.

In another embodiment, at least one jaw clamp of the second column of jaw clamps can be vertically adjustable in the glass ribbon travel direction relative to at least one jaw clamp of the first column of jaw clamps.

In another embodiment, a first jaw clamp of the first column of jaw clamps and a first jaw clamp of the second column of jaw clamps can form a first elevational pair of jaw clamps positioned at a first elevation. A second jaw clamp of the first column of jaw clamps and a second jaw clamp of the second column of jaw clamps can form a second elevational pair of jaw clamps positioned at a second elevation.

In another embodiment, a first lateral spacing between the jaw clamps of the first elevational pair of jaw clamps can be adjustable in the lateral direction.

In another embodiment, the first lateral spacing between the jaw clamps of the first elevational pair of jaw clamps can be adjustable in the lateral direction independent of a second lateral spacing between the jaw clamps of the second elevational pair of jaw clamps.

In another embodiment, a second lateral spacing between the jaw clamps of the second elevational pair of jaw clamps can be adjustable in the lateral direction.

In another embodiment, the second lateral spacing between the jaw clamps of the second elevational pair of jaw clamps can be adjustable in the lateral direction independent of a first lateral spacing between the jaw clamps of the first elevational pair of jaw clamps.

In another embodiment, a method can be provided for manufacturing a glass ribbon with the glass manufacturing apparatus. Methods can comprise moving the glass ribbon along the glass ribbon travel direction. The glass ribbon can comprise a first major surface and a second major surface. Methods can further comprise clamping a first lateral edge of the glass ribbon with the first column of jaw clamps by engaging the first major surface and the second major surface with each jaw clamp of the first column of jaw clamps. Methods can further comprise clamping a second lateral edge of the glass ribbon with the second column of jaw clamps by engaging the first major surface and the second major surface with each jaw clamp of the second column of jaw clamps.

In another embodiment, methods can further comprise separating the glass ribbon from another portion of the glass ribbon and catching the separated glass ribbon with the clamping of the first lateral edge and the second lateral edge of the glass ribbon.

In another embodiment, methods can further comprise engaging a lower edge of the glass ribbon prior to clamping the first lateral edge and the second lateral edge of the glass ribbon.

In another embodiment, methods can further comprise adjusting a first lateral spacing between a first jaw clamp of the first column of jaw clamps and a first jaw clamp of the second column of jaw clamps to adjust a first lateral tension of the glass ribbon at a first elevation.

In another embodiment, the adjusted first lateral tension of the glass ribbon at the first elevation can be different than a second lateral tension of the glass ribbon at the second elevation of the glass ribbon.

In another embodiment, methods can further comprise adjusting a second lateral spacing between a second jaw clamp of the first column of jaw clamps and a second jaw clamp of the second column of jaw clamps to adjust a second lateral tension at a second elevation of the glass ribbon.

In another embodiment, adjusting the second lateral tension can be conducted independent of adjusting the first lateral tension.

In another embodiment, the adjusted first lateral tension can be different than the adjusted second lateral tension.

In another embodiment, the first column of jaw clamps, the second column of jaw clamps, and the glass ribbon can move together at the same velocity along the glass ribbon travel direction prior to clamping the first lateral edge of the glass ribbon with the first column of jaw clamps and prior to clamping a second lateral edge of the glass ribbon with the second column of jaw clamps.

In another embodiment, the first column of jaw clamps, the second column of jaw clamps, and the glass ribbon can move together at the same velocity along the glass ribbon travel direction after clamping the first lateral edge of the glass ribbon with the first column of jaw clamps and after clamping a second lateral edge of the glass ribbon with the second column of jaw clamps.

### BRIEF DESCRIPTION OF THE DRAWINGS

These and other features, aspects and advantages are better understood when the following detailed description is read with reference to the accompanying drawings, in which:

FIG. 1 schematically illustrates an exemplary embodiment of a glass manufacturing apparatus in accordance with embodiments of the disclosure;

FIG. 2 illustrates a perspective cross-sectional view of the glass manufacturing apparatus along line 2-2 of FIG. 1 in accordance with embodiments of the disclosure;

FIG. 3 is a schematic end view of an exemplary embodiment of glass ribbon sources in accordance with embodiments of the disclosure;

FIG. 4 is a front view of an exemplary embodiment of a glass ribbon gripping device in accordance with embodiments of the disclosure;

FIG. 5 illustrates an end view of an exemplary embodiment of the glass ribbon gripping device along line 5-5 of FIG. 4 in accordance with embodiments of the disclosure;

FIG. 6 illustrates an enlarged front view of an exemplary embodiment of a jaw clamp of the glass ribbon gripping device in accordance with embodiments of the disclosure;

FIG. 7 illustrates an enlarged side view of an exemplary embodiment of the jaw clamp of the glass ribbon gripping device in accordance with embodiments of the disclosure;

FIG. 8 illustrates an enlarged side view of an exemplary embodiment of a support surface of the glass ribbon gripping device in accordance with embodiments of the disclosure;

FIG. 9 is a front view of an exemplary embodiment of the glass ribbon gripping device comprising jaw clamps in an unclamped position in accordance with embodiments of the disclosure;

FIG. 10 is a front view of an exemplary embodiment of the glass ribbon gripping device comprising jaw clamps in the unclamped position and a glass ribbon moving relative to the glass ribbon gripping device in accordance with embodiments of the disclosure;

FIG. 11 is a front view of an exemplary embodiment of the glass ribbon gripping device comprising jaw clamps in the unclamped position with the glass ribbon engaging the support surface in accordance with embodiments of the disclosure;

FIG. 12 is a front view of an exemplary embodiment of the glass ribbon gripping device comprising jaw clamps in a clamped position with the glass ribbon engaging the support surface in accordance with embodiments of the disclosure;

FIG. 13 is a front view of an exemplary embodiment of the glass ribbon gripping device comprising jaw clamps in the unclamped position in accordance with embodiments of the disclosure;

FIG. 14 is a front view of an exemplary embodiment of the glass ribbon gripping device comprising jaw clamps in the clamped position with the glass ribbon being separated from another portion of the glass ribbon;

FIG. 15 is a front view of an exemplary embodiment of the glass ribbon gripping device comprising jaw clamps in the clamped position with the glass ribbon not engaging the support surface in accordance with embodiments of the disclosure;

FIG. 16 is a front view of an exemplary embodiment of the glass ribbon gripping device comprising jaw clamps in the clamped position with the glass ribbon and the glass ribbon gripping device moving together along a glass ribbon travel direction in accordance with embodiments of the disclosure;

FIG. 17 is a front view of an exemplary embodiment of the glass ribbon gripping device with a first elevational pair of jaw clamps being adjustable in accordance with embodiments of the disclosure;

FIG. 18 is a front view of an exemplary embodiment of the glass ribbon gripping device with a second elevational pair of jaw clamps being adjustable in accordance with embodiments of the disclosure;

FIG. 19 is a front view of an exemplary embodiment of the glass ribbon gripping device with the jaw clamps being vertically adjustable along the glass ribbon travel direction in accordance with embodiments of the disclosure; and

FIG. 20 illustrates an enlarged side view of an exemplary embodiment of the jaw clamp in the clamped position and the glass ribbon gripping device applying a force to the glass ribbon along a bending direction that is perpendicular to the glass ribbon travel direction in accordance with embodiments of the disclosure.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

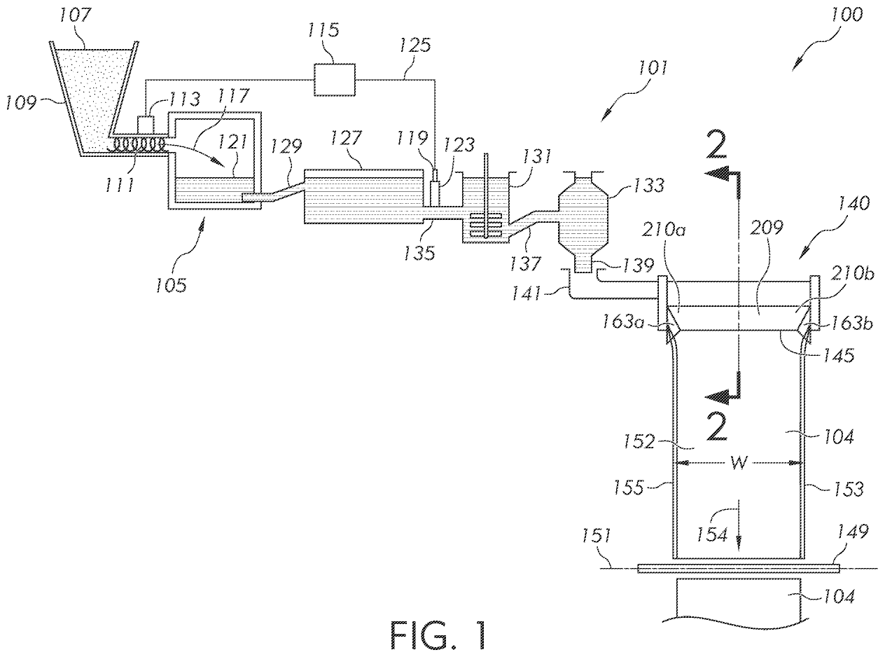

It is to be understood that specific embodiments disclosed herein are intended to be exemplary and therefore non-limiting. For purposes of the disclosure, although not required, the glass manufacturing apparatus can optionally comprise a glass forming apparatus that forms a glass sheet and/or glass ribbon from a quantity of molten material. For example, the glass manufacturing apparatus can optionally comprise a glass forming apparatus such as a slot draw apparatus, float bath apparatus, down-draw apparatus, up-draw apparatus, press-rolling apparatus or other glass forming apparatus. In the embodiment illustrated in FIG. 1 discussed below, the glass manufacturing apparatus can comprise a glass forming apparatus comprising a fusion down-draw apparatus although other glass forming apparatus maybe provided in further embodiments.

Furthermore, for purposes of the disclosure, although not required, the glass manufacturing apparatus can comprise a storage device for storing a previous-formed glass ribbon and/or glass sheet. For example, although not shown, the glass manufacturing apparatus may optionally comprise a storage spool comprising a length of the glass ribbon wound on the storage spool. In some embodiments, the glass manufacturing apparatus may unwind a portion of the glass ribbon from the storage spool during a method of manufacturing the glass ribbon.

As schematically illustrated in FIG. 1, in some embodiments, an exemplary glass manufacturing apparatus 100 can comprise a glass forming apparatus 101 comprising a forming vessel 140 designed to produce a glass ribbon 104 from a quantity of molten material 121. In some embodiments, the glass ribbon 104 can comprise a central portion 152 disposed between opposite, relatively thick edge beads formed along a first lateral edge 153 and a second lateral edge 155 of the glass ribbon 104. Additionally, in some embodiments, a portion of the glass ribbon 104 can be separated along a separation path 151 by a glass separator 149 (e.g., scribe, score wheel, diamond tip, laser, etc.). In some embodiments, before or after separation of the portion of the glass ribbon 104 with the glass separator 149, the relatively thick edge beads formed along the first lateral edge 153 and the second lateral edge 155 can be removed to provide the central portion 152 as a high-quality glass ribbon 104 having a uniform thickness.

In some embodiments, the glass manufacturing apparatus 100 can comprise a melting vessel 105 oriented to receive batch material 107 from a storage bin 109. The batch material 107 can be introduced by a batch delivery device 111 powered by a motor 113. In some embodiments, an optional controller 115 can be operated to activate the motor 113 to introduce a desired amount of batch material 107 into the melting vessel 105, as indicated by arrow 117. The melting vessel 105 can heat the batch material 107 to provide molten material 121. In some embodiments, a glass melt probe 119 can be employed to measure a level of molten material 121 within a standpipe 123 and communicate the measured information to the controller 115 by way of a communication line 125.

Additionally, in some embodiments, the glass manufacturing apparatus 100 can comprise a first conditioning station comprising a fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 through an interior pathway of the first connecting conduit 129 from the melting vessel 105 to the fining vessel 127. Additionally, in some embodiments, bubbles can be removed from the molten material 121 within the fining vessel 127 by various techniques.

In some embodiments, the glass manufacturing apparatus 100 can further comprise a second conditioning station comprising a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 through an interior pathway of the second connecting conduit 135 from the fining vessel 127 to the mixing chamber 131.

Additionally, in some embodiments, the glass manufacturing apparatus 100 can comprise a third conditioning station comprising a delivery vessel 133 that can be located downstream from the mixing chamber 131. In some embodiments, the delivery vessel 133 can condition the molten material 121 to be fed into an inlet conduit 141. For example, the delivery vessel 133 can function as an accumulator and/or flow controller to adjust and provide a consistent flow of molten material 121 to the inlet conduit 141. As shown, the mixing chamber 131 can be coupled to the delivery vessel 133 by way of a third connecting conduit 137. In some embodiments, molten material 121 can be gravity fed from the mixing chamber 131 to the delivery vessel 133 by way of the third connecting conduit 137. For example, in some embodiments, gravity can drive the molten material 121 through an interior pathway of the third connecting conduit 137 from the mixing chamber 131 to the delivery vessel 133. As further illustrated, in some embodiments, a delivery pipe 139 (e.g., downcomer) can be positioned to deliver molten material 121 to the inlet conduit 141 of the forming vessel 140.

Various embodiments of forming vessels can be provided in accordance with features of the disclosure comprising a forming vessel with a wedge for fusion drawing the glass ribbon, a forming vessel with a slot to slot draw the glass ribbon, or a forming vessel provided with press rolls to press roll the glass ribbon from the forming vessel. By way of illustration, the forming vessel 140 shown and disclosed below can be provided to fusion draw molten material 121 off a root 145 of a forming wedge 209 to produce the glass ribbon 104. For example, in some embodiments, the molten material 121 can be delivered from the inlet conduit 141 to the forming vessel 140. The molten material 121 can then be formed into the glass ribbon 104 based at least in part on the structure of the forming vessel 140. For example, as shown, the molten material 121 can be drawn off the bottom edge (e.g., root 145) of the forming vessel 140 along a draw path extending in a glass ribbon travel direction 154 of the glass manufacturing apparatus 100. In some embodiments, edge directors 163a, 163b can direct the molten material 121 off the forming vessel 140 and define, at least in part, a width “W” of the glass ribbon 104. In some embodiments, the width “W” of the glass ribbon 104 can extend between the first lateral edge 153 of the glass ribbon 104 and the second lateral edge 155 of the glass ribbon 104.

In some embodiments, the width “W” of the glass ribbon 104 can be greater than or equal to about 20 mm, such as greater than or equal to about 50 mm, such as greater than or equal to about 100 mm, such as greater than or equal to about 500 mm, such as greater than or equal to about 1000 mm, such as greater than or equal to about 2000 mm, such as greater than or equal to about 3000 mm, such as greater than or equal to about 4000 mm, although other widths less than or greater than the widths mentioned above can be provided in further embodiments. For example, in some embodiments, the width “W” of the glass ribbon 104 can be from about 20 mm to about 4000 mm, such as from about 50 mm to about 4000 mm, such as from about 100 mm to about 4000 mm, such as from about 500 mm to about 4000 mm, such as from about 1000 mm to about 4000 mm, such as from about 2000 mm to about 4000 mm, such as from about 3000 mm to about 4000 mm, such as from about 20 mm to about 3000 mm, such as from about 50 mm to about 3000 mm, such as from about 100 mm to about 3000 mm, such as from about 500 mm to about 3000 mm, such as from about 1000 mm to about 3000 mm, such as from about 2000 mm to about 3000 mm, such as from about 2000 mm to about 2500 mm, and all ranges and subranges therebetween.

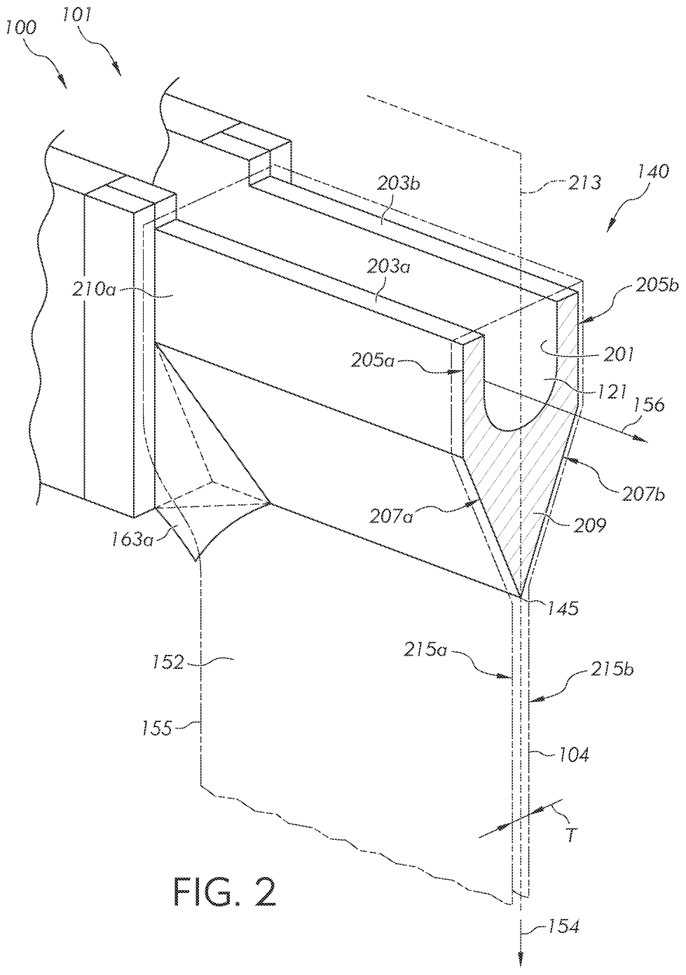

FIG. 2 shows a cross-sectional perspective view of the glass manufacturing apparatus 100 along line 2-2 of FIG. 1. In some embodiments, the forming vessel 140 can comprise a trough 201 oriented to receive the molten material 121 from the inlet conduit 141. For illustrative purposes, cross-hatching of the molten material 121 is removed from FIG. 2 for clarity. The forming vessel 140 can further comprise the forming wedge 209 comprising a pair of downwardly inclined converging surface portions 207a, 207b extending between opposed ends 210a, 210b (See FIG. 1) of the forming wedge 209. The pair of downwardly inclined converging surface portions 207a, 207b of the forming wedge 209 can converge along the glass ribbon travel direction 154 to intersect along a bottom edge of the forming wedge 209 to define the root 145 of the forming vessel 140. A draw plane 213 of the glass manufacturing apparatus 100 can extend through the root 145 along the glass ribbon travel direction 154. In some embodiments, the glass ribbon 104 can be drawn in the glass ribbon travel direction 154 along the draw plane 213. As shown, the draw plane 213 can bisect the forming wedge 209 through the root 145 although, in some embodiments, the draw plane 213 can extend at other orientations relative to the root 145.

Additionally, in some embodiments, the molten material 121 can flow in a direction 156 into the trough 201 of the forming vessel 140. The molten material 121 can then overflow from the trough 201 by simultaneously flowing over corresponding weirs 203a, 203b and downward over the outer surfaces 205a, 205b of the corresponding weirs 203a, 203b. Respective streams of molten material 121 can then flow along the downwardly inclined converging surface portions 207a, 207b of the forming wedge 209 to be drawn off the root 145 of the forming vessel 140, where the flows converge and fuse into the glass ribbon 104. The glass ribbon 104 can then be fusion drawn off the root 145 in the draw plane 213 along the glass ribbon travel direction 154. In some embodiments, the glass separator 149 (see FIG. 1) can then subsequently separate a portion of the glass ribbon 104 along the separation path 151. For example, as shown in FIG. 1, a portion of a glass ribbon 104 in the form of a glass sheet can be separated from the glass ribbon 104 along the separation path 151. As illustrated, in some embodiments, the separation path 151 can extend along the width “W” of the glass ribbon 104 between the first lateral edge 153 and the second lateral edge 155. Additionally, in some embodiments, the separation path 151 can extend perpendicular to the glass ribbon travel direction 154 of the glass ribbon 104. Moreover, in some embodiments, the glass ribbon travel direction 154 can define a direction along which the glass ribbon 104 can be fusion drawn from the forming vessel 140. In some embodiments, the glass ribbon 104 can include a speed as it traverses along the glass ribbon travel direction 154 of ≥50 mm/s, ≥100 mm/s, or ≥500 mm/s, for example, from about 50 mm/s to about 500 mm/s, such as from about 100 mm/s to about 500 mm/s, and all ranges and subranges therebetween.

As shown in FIG. 2, the glass ribbon 104 can be drawn from the root 145 with a first major surface 215a of the glass ribbon 104 and a second major surface 215b of the glass ribbon 104 facing opposite directions and defining a thickness “T” (e.g., average thickness) of the glass ribbon 104. In some embodiments, the thickness “T’ of the glass ribbon 104 can be less than or equal to about 2 millimeters (mm), less than or equal to about 1 millimeter, less than or equal to about 0.5 millimeters, for example, less than or equal to about 300 micrometers (μm), less than or equal to about 200 micrometers, or less than or equal to about 100 micrometers, although other thicknesses may be provided in further embodiments. For example, in some embodiments, the thickness “T’ of the glass ribbon 104 can be from about 50 μm to about 750 μm, from about 100 μm to about 700 μm, from about 200 μm to about 600 μm, from about 300 μm to about 500 μm, from about 50 μm to about 500 μm, from about 50 μm to about 700 μm, from about 50 μm to about 600 μm, from about 50 μm to about 500 μm, from about 50 μm to about 400 μm, from about 50 μm to about 300 μm, from about 50 μm to about 200 μm, from about 50 μm to about 100 μm, including all ranges and subranges of thicknesses therebetween. In addition, the glass ribbon 104 can comprise a variety of compositions comprising, but not limited to, soda-lime glass, borosilicate glass, alumino-borosilicate glass, alkali-containing glass, or alkali-free glass.

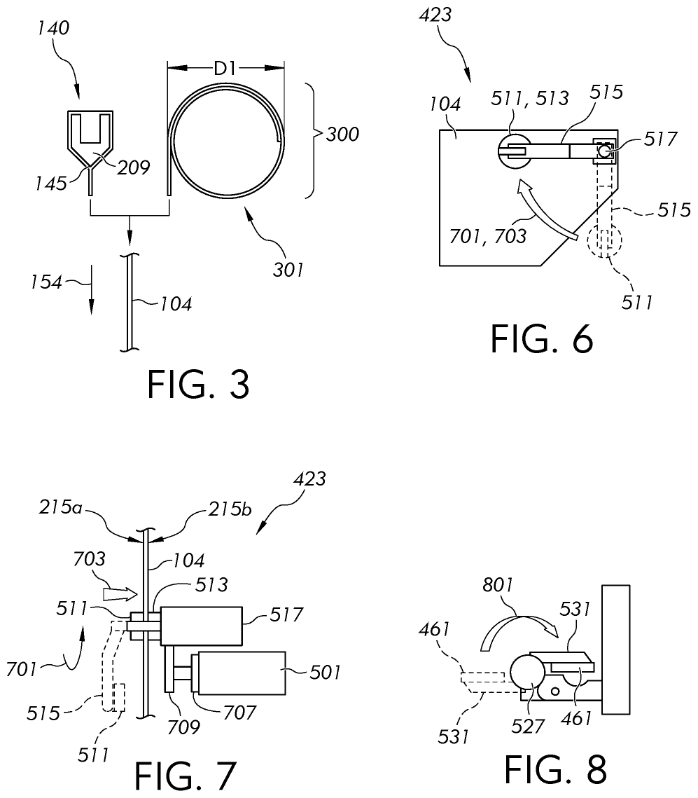

Referring to FIG. 3, it will be appreciated that the glass ribbon 104 may be provided by one or more types of sources 300. FIG. 3 illustrates two example sources 300 of the glass ribbon 104, though other sources may be provided in further embodiments. For instance, in some embodiments, one source 300 may comprise the forming vessel 140 illustrated and described with respect to FIGS. 1 and 2. The forming vessel 140 may comprise the forming wedge 209 comprising the downwardly inclined converging surface portions 207a, 207b and the root 145.

In another embodiment, another source 300 of the glass ribbon 104 may comprise a coiled spool 301 of ribbon (e.g., glass ribbon). For example, the glass ribbon 104 may be wound into the coiled spool 301 after being drawn into a glass ribbon from a quantity of the molten material 121, for example, with the forming vessel 140. The glass ribbon of the coiled spool 301 may or may not have the edge beads formed along the first lateral edge 153 and the second lateral edge 155 of the glass ribbon 104. However, if a greater thickness of edge beads is present, the edge beads may increase the bend radius that avoids cracking or breaking the glass ribbon 104. As such, if coiled, the glass ribbon 104 may be coiled with a relatively large bend radius such that a given length of the glass ribbon may use the coiled spool 301 with a relatively large diameter “Dl.” In contrast, if the edge beads are removed, the glass ribbon 104 may be coiled with a relatively small bend radius. If the source 300 comprises the coiled spool 301, the glass ribbon 104 may be uncoiled from the coiled spool 301 to traverse in the glass ribbon travel direction 154. As shown, in some embodiments, the glass ribbon travel direction 154 may comprise the direction of gravity although the glass ribbon travel direction 154 can comprise a lateral draw direction traveling at an angle (e.g., perpendicular) to gravity depending on the source of the glass ribbon 104 and/or configuration of the glass manufacturing apparatus 100.

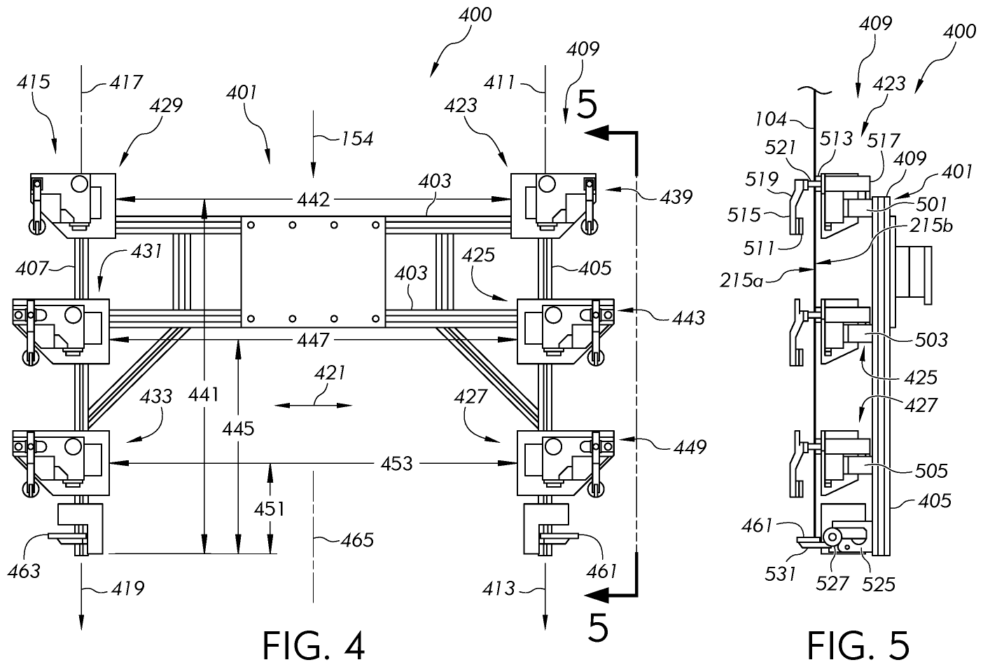

Referring to FIG. 4, the glass manufacturing apparatus 100 may comprise a glass ribbon gripping device 400. The glass ribbon gripping device 400 may be disposed downstream from the source 300 (e.g., the forming vessel 140 or the coiled spool 301). In some embodiments, the glass ribbon gripping device 400 may assist in handling and/or directing movement of the glass ribbon 104. For example, the glass ribbon gripping device 400 can handle and/or direct movement of the glass ribbon 104 prior to, during, and/or after the separation of the portion of the glass ribbon 104 by the glass separator 149.

The glass ribbon gripping device 400 can comprise a frame 401 that can comprise one or more frame arms. In some embodiments, the frame 401 can comprise one or more lateral frame arms 403 that can extend in a direction that may be perpendicular to the glass ribbon travel direction 154 although the frame arms can extend in non-perpendicular directions in further embodiments. While the embodiment of FIG. 4 is illustrated as comprising two lateral frame arms 403, it will be appreciated that the glass ribbon gripping device 400 may comprise any number of lateral frame arms 403 extending perpendicular and/or at other angles relative to the glass ribbon travel direction 154.

In some embodiments, the frame 401 can comprise one or more vertical frame arms, such as a first vertical frame arm 405 and a second vertical frame arm 407. In some embodiments, the first vertical frame arm 405 and the second vertical frame arm 407 can extend parallel to one another although non-parallel configurations may be provided in further embodiments. As shown, in some embodiments, the first vertical frame arm 405 and the second vertical frame arm 407 can also extend in the glass ribbon travel direction 154, although, in other embodiments, the first vertical frame arm 405 and the second vertical frame arm 407 can extend non-parallel to the glass ribbon travel direction 154. In some embodiments, the first vertical frame arm 405 and the second vertical frame arm 407 may be attached to opposing ends of the lateral frame arms 403. For example, a first end of the lateral frame arms 403 may be attached to the first vertical frame arm 405 while an opposing second end of the lateral frame arms 403 may be attached to the second vertical frame arm 407. In some embodiments, the first vertical frame arm 405 and the second vertical frame arm 407 may be spaced apart from each other and maintained with a substantially fixed distance between the first vertical frame arm 405 and the second vertical frame arm 407. In some embodiments, the frame 401 may comprise one or more additional angled frame arms that can be attached to one or more of the lateral frame arms 403, the first vertical frame arms 405, and/or the second vertical frame arm 407. These angled frame arms may extend parallel to, perpendicular to, or at an angle other than parallel or perpendicular to the glass ribbon travel direction 154. In some embodiments, the frame 401 may comprise a substantially rigid material, such as a metal material, that can be limited from experiencing inadvertent bending, flexing, etc.

The glass ribbon gripping device 400 may comprise one or more columns of jaw clamps. For example, the glass ribbon gripping device 400 may comprise a first column of jaw clamps 409 spaced from one another along a first clamp path 411 extending in the glass ribbon travel direction 154 of the glass manufacturing apparatus 100. The glass ribbon gripping device 400 may comprise a second column of jaw clamps 415 spaced from one another along a second clamp path 417 extending in the glass ribbon travel direction 154 of the glass manufacturing apparatus 100. In some embodiments, the first clamp path 411, which may extend in a first clamp direction 413 of the glass ribbon travel direction 154, may be substantially parallel to the second clamp path 417, which may extend in a second clamp direction 419 of the glass ribbon travel direction 154, such that the first column of jaw clamps 409 may be arranged substantially parallel to the second column of jaw clamps 415. The first column of jaw clamps 409 may be attached to the first vertical frame arm 405 and the second column of jaw clamps 415 may be attached to the second vertical frame arm 407. By being attached to the first vertical frame arm 405 and the second vertical frame arm 407, the first column of jaw clamps 409 and the second column of jaw clamps 415 may be spaced apart in a lateral direction 421 that can be perpendicular to the glass ribbon travel direction 154.

In some embodiments, the first clamp path 411 and the second clamp path 417 may or may not extend vertically in the direction of gravity. Rather, in some embodiments, the first clamp path 411 and the second clamp path 417 may be positioned to extend at an angle with respect to the direction of gravity, wherein a vector of the first clamp path 411 and the second clamp path 417 has a vertical component in the direction of gravity and a horizontal component in a direction perpendicular to the direction of gravity. In some embodiments, the glass ribbon travel direction 154 can extend in the direction of gravity or may likewise extend at an angle with respect to the direction of gravity.

In some embodiments, the first column of jaw claims 409 and the second column of jaw clamps 415 may each comprise two or more jaw clamps. For instance, in the illustrated embodiment, the first column of jaw clamps 409 may comprise a first jaw clamp 423, a second jaw clamp 425, and a third jaw clamp 427. The first jaw clamp 423 may be located at a higher elevation that the second jaw clamp 425 and the third jaw claim 427 and in closer proximity to the source 300 than the second jaw clamp 425 and the third jaw clamp 427. The second jaw clamp 425 may be disposed at an elevation between the elevation of the first jaw clamp 423 and an elevation of the third jaw clamp 427 along the first clamp path 411. In some embodiments, a first spacing between the first jaw clamp 423 and the second jaw clamp 425 may be equal to a second spacing between the second jaw clamp 425 and the third jaw clamp 427. However, as will be described herein, the first spacing and the second spacing may be adjustable and non-constant. For instance, in some embodiments, the first jaw clamp 423, the second jaw clamp 425, and/or the third jaw clamp 427 may be vertically adjustable relative to the frame 401. In some embodiments, the first spacing between the first jaw clamp 423 and the second jaw clamp 425 may be greater than, equal to, or less than the second spacing between the second jaw clamp 425 and the third jaw clamp 427. In some embodiments, the first jaw clamp 423, the second jaw clamp 425, and the third jaw clamp 427 may be aligned substantially coaxially along the first clamp path 411. However, as will be described herein, the first jaw clamp 423, the second jaw clamp 425, and/or the third jaw clamp 427 may be laterally adjustable along the lateral direction 421 relative to the frame 401. By adjusting one or more of the first jaw clamp 423, the second jaw clamp 425, and/or the third jaw clamp 427 laterally along the lateral direction 421, the first jaw clamp 423, the second jaw clamp 425, and/or the third jaw clamp 427 may be arranged non-coaxially.

Still further, in the illustrated embodiment, the second column of jaw clamps 415 may comprise a first jaw clamp 429, a second jaw clamp 431, and a third jaw clamp 433. The first jaw clamp 429 may be located at a higher elevation than the second jaw clamp 431 and the third jaw clamp 433 and in closer proximity to the source 300 than the second jaw clamp 431 and the third jaw clamp 433. The second jaw clamp 431 may be disposed at an elevation between the elevation of first jaw clamp 429 and an elevation of the third jaw clamp 433 along the second clamp path 417. In some embodiments, a first spacing between the first jaw clamp 429 and the second jaw clamp 431 may be equal to a second spacing between the second jaw clamp 431 and the third jaw clamp 433. However, as will be described herein, the first spacing and the second spacing may be adjustable and non-constant. For instance, in some embodiments, the first jaw clamp 429, the second jaw clamp 431, and/or the third jaw clamp 433 be vertically adjustable relative to the frame 401. In some embodiments, the first spacing between the first jaw clamp 429 and the second jaw clamp 431 may be greater than, equal to, or less than the second spacing between the second jaw clamp 431 and the third jaw clamp 433. In some embodiments, the first jaw clamp 429, the second jaw clamp 431, and the third jaw clamp 433 may be aligned substantially coaxially along the second clamp path 417. However, as will be described herein, the first jaw clamp 429, the second jaw clamp 431, and/or the third jaw clamp 433 may be laterally adjustable along the lateral direction 421 relative to the frame 401. By adjusting one or more of the first jaw clamp 429, the second jaw clamp 431, and/or the third jaw clamp 433 laterally along the lateral direction 421, the first jaw clamp 429, the second jaw clamp 431, and/or the third jaw clamp 433 may be arranged non-coaxially.

In some embodiments, the first column of jaw clamps 409 and the second column of jaw clamps 415 may form one or more elevational pairs. For example, the first jaw clamp 423 of the first column of jaw clamps 409 and the first jaw clamp 429 of the second column of jaw clamps 415 may form a first elevational pair 439 of jaw clamps positioned at a first elevation 441, wherein the first elevation 441 represents a distance from the first elevational pair 439 of jaw clamps to a bottom of the glass ribbon gripping device 400. A first lateral spacing 442 may be defined between the first jaw clamp 423 of the first column of jaw clamps 409 and the first jaw clamp 429 of the second column of jaw clamps 415. In some embodiments, the second jaw clamp 425 of the first column of jaw clamps 409 and the second jaw clamp 431 of the second column of jaw clamps 415 may form a second elevational pair 443 of jaw clamps positioned at a second elevation 445, wherein the second elevation 445 represents a distance from the second elevational pair 443 of jaw clamps to a bottom of the glass ribbon gripping device 400. A second lateral spacing 447 may be defined between the second jaw clamp 425 of the first column of jaw clamps 409 and the second jaw clamp 431 of the second column of jaw clamps 415. In some embodiments, the third jaw clamp 427 of the first column of jaw clamps 409 and the third jaw clamp 433 of the second column of jaw clamps 415 may form a third elevational pair 449 of jaw clamps positioned at a third elevation 451, wherein the third elevation 451 represents a distance from the third elevational pair 449 of jaw clamps to a bottom of the glass ribbon gripping device 400. A third lateral spacing 453 may be defined between the third jaw clamp 427 of the first column of jaw clamps 409 and the third jaw clamp 433 of the second column of jaw clamps 415.

In some embodiments the glass ribbon gripping device 400 may comprise at least one support surface positioned at an elevation at or below the lowest jaw clamp. For instance, in the illustrated embodiment, a support surface can be positioned below at least one of the first column of jaw clamps 409 and the second column of jaw clamps 415, with the support surface extending across a travel path 465 of the glass ribbon 104. The support surface may comprise, for example, a first support surface 461 and a second support surface 463 that may optionally be attached directly or indirectly to the frame 401. For example, in the illustrated embodiment, the first support surface 461 may be attached to the first vertical frame arm 405 while the second support surface 463 may be attached to the second vertical frame arm 407. As shown, in some embodiments, the third jaw clamp 427 may be attached to the first vertical frame arm 405 at an elevation between the elevation of the second jaw clamp 425 and the elevation of the first support surface 461. Similarly, in some embodiments, the third jaw clamp 433 may be attached to the second vertical frame arm 407 at an elevation between the elevation of the second jaw clamp 431 and the elevation of the second support surface 463.

The first support surface 461 and the second support surface 463 may extend at least partially across the travel path 465 of the glass ribbon 104. In the illustrated example, the first support surface 461 and the second support surface 463 extend partially across the travel path 465 of the glass ribbon 104, although one or more support surfaces may extend entirely across the travel path in further embodiments. Indeed, in the illustrated embodiment, the first support surface 461 and the second support surface 463 may be disposed towards lower corners of the frame 401 to provide support for the glass ribbon 104 at opposite edge portions of the glass ribbon 104. Supporting at opposite edge portions can be beneficial in some embodiments since the edge portions may be removed at a subsequent time wherein only high-quality glass ribbon areas not physically contacted by the glass ribbon gripping device 400 remain after removal of the edge portions. In other embodiments, however, the support surface may extend completely across the travel path 465, with one end of the support surface attached to the first vertical frame arm 405 and an opposing second end of the support surface attached to the second vertical frame arm 407. In such an embodiment, the support surface may comprise a bar or other similar structure that may extend between the first vertical frame arm 405 and the second vertical frame arm 407. Extending the support surface completely across the travel path may be beneficial to reduce stress concentrations on the lower edge of the glass ribbon.

FIG. 5 shows an end view of the glass ribbon gripping device 400 along line 5-5 of FIG. 4. The glass ribbon 104 is illustrated in FIG. 5 in relation to the glass ribbon gripping device 400 and extending along the travel path 465. While FIG. 5 illustrates the first column of jaw clamps 409 (e.g., the first jaw clamp 423, the second jaw clamp 425, and the third jaw clamp 427), the first support surface 461, and the first vertical frame arm 405, it will be appreciated that the second column of jaw clamps 415 (e.g., the first jaw clamp 429, the second jaw clamp 431, and the third jaw clamp 433), the second vertical frame arm 407, and the second support surface 463 may be substantially similar in structure and function.

Focusing upon the structure of the frame 401, in some embodiments, the first major surface 215a of the glass ribbon 104 can face away from the frame 401 while the second major surface 215b of the glass ribbon 104 can face towards the frame 401. The frame 401 may optionally comprise one or more protruding arms, such as a first protruding arm 501, a second protruding arm 503, and a third protruding arm 505. The first protruding arm 501, the second protruding arm 503, and the third protruding arm 505, if provided, can extend substantially perpendicular or at another angle relative to the first vertical frame arm 405, and may be directly or indirectly attached to the first vertical frame arm 405. In some embodiments, the first protruding arm 501, the second protruding arm 503, and the third protruding arm 505 can extend from the first vertical frame arm 405 towards the second major surface 215b of the glass ribbon 104. The first jaw clamp 423 may be attached to the first protruding arm 501, the second jaw clamp 425 may be attached to the second protruding arm 503, and the third jaw clamp 427 may be attached to the third protruding arm 505.

Focusing upon the structure of the first jaw clamp 423, the first jaw clamp 423 can comprise a first pad 511 and a second pad 513. The first pad 511 and the second pad 513 can be positioned on opposing sides of the glass ribbon 104. For example, the first pad 511 can be positioned to face the first major surface 215a while the second pad 513 can be positioned to face the second major surface 215b. Together, the first pad 511 and the second pad 513 can be brought together to clamp the glass ribbon 104.

In some embodiments, the first pad 511 can be attached to an attachment arm 515. The attachment arm 515 can be attached at one end to the first pad 511 and at an opposing end to a rotational cylinder 517. The rotational cylinder 517 can impart movement to the attachment arm 515. For example, the rotational cylinder 517 can cause the attachment arm 515 to rotate along a rotation path that can be parallel to the first major surface 215a of the glass ribbon 104 (e.g., into and out of the page in FIG. 5). In addition, the rotational cylinder 517 can cause the attachment arm 515 to translate in a clamping direction that can be perpendicular to the first major surface 215a of the glass ribbon 104 (e.g., left and right in FIG. 5).

In some embodiments, the attachment arm 515 may comprise a first arm portion 519 and a second arm portion 521. The first arm portion 519 can extend substantially parallel to the glass ribbon 104 while the second arm portion 521 may extend substantially perpendicular to the glass ribbon 104. In some embodiments, the second arm portion 521 may be attached to the rotational cylinder 517, such as by being received within a recess of the rotational cylinder 517, for example. The first arm portion 519 can be attached to the second arm portion 521 at an opposite end of the second arm portion 521 from the rotational cylinder 517. The first pad 511 can be attached to the first arm portion 519 at an opposite end of the first arm portion 519 from the attachment of the first arm portion 519 and the second arm portion 521. For example, the first pad 511 can be attached to an inner side of the first arm portion 519, such that the first pad 511 faces the first major surface 215a.

The rotational cylinder 517 can cause the attachment arm 515 and the first pad 511 to move between a clamped position and an unclamped position. For example, in the unclamped position that is illustrated in FIG. 5, the first pad 511 may not contact the glass ribbon 104 or may contact the glass ribbon 104 with a magnitude of force that may be low enough to not restrain movement of the glass ribbon 104 relative to the first pad 511 and the second pad 513. In the clamped position (e.g., illustrated in FIGS. 6 and 7), the first pad 511 and the second pad 513 may contact the glass ribbon 104 and apply a force, such as a compressive force, to the glass ribbon 104 that can be sufficient to restrain movement of the glass ribbon 104 relative to the first pad 511 and the second pad 513.

While the foregoing description of the structure and function of a jaw clamp was made relative to the first jaw clamp 423, it will be appreciated that the other jaw clamps (e.g., the second jaw clamp 425 and the third jaw clamp 427 of the first column of jaw clamps 409 and the first jaw clamp 429, the second jaw clamp 431, and the third jaw clamp 433 of the second column of jaw clamps 415) may be substantially similar in structure and function to the first jaw clamp 423. For example, the second jaw clamp 425 and the third jaw clamp 427 of the first column of jaw clamps 409, and the first jaw clamp 429, the second jaw clamp 431, and the third jaw clamp 433 of the second column of jaw clamps 415 may comprise the structures of the first jaw clamp 423, such as the first pad 511, the second pad 513, the attachment arm 515 comprising the first arm portion 519 and the second arm portion 521, the rotational cylinder 517, etc. In these embodiments, the second jaw clamp 425 and the third jaw clamp 427 of the first column of jaw clamps 409, and the first jaw clamp 429, the second jaw clamp 431, and the third jaw clamp 433 of the second column of jaw clamps 415 can move in a similar fashion to the first jaw clamp 423 between the unclamped position (e.g., illustrated in FIG. 5) and the clamped position (e.g., illustrated in FIGS. 6 and 7). In these embodiments, the jaw clamps can function together to selectively allow for the glass ribbon 104 to move relative to the glass ribbon gripping device 400 when the jaw clamps are in the unclamped position, and to restrain movement of the glass ribbon 104 relative to the glass ribbon gripping device 400 when the jaw clamps are in the clamped position.

Focusing upon the structure of the first support surface 461, the first support surface 461 can optionally be attached to an attachment arm 525, which can be attached directly or indirectly to the frame 401. In some embodiments, the attachment arm 525 may be attached to a lower end of the frame 401 and may extend in a direction that can be substantially perpendicular or at another direction relative to the frame 401 and the glass ribbon 104. The glass ribbon gripping device 400 can comprise a rotational arm 527 that may be rotationally coupled to the attachment arm 525. In some embodiments, the rotational arm 527 may be rotatably coupled to the attachment arm 525. In some embodiments, the glass ribbon gripping device 400 may comprise one or more gears, motors, actuators, or the like coupled to the rotational arm 527 to impart rotation of the rotational arm 527 relative to the attachment arm 525.

The first support surface 461 can be attached to a support arm 531 that can be attached to the rotational arm 527. In some embodiments, the support arm 531 can extend outwardly from the rotational arm 527 in a direction that can be substantially perpendicular to the glass ribbon 104. The support arm 531 may be fixedly attached to the rotational arm 527, such that movement of the rotational arm 527 can likewise impart movement to the support arm 531. In some embodiments, the first support surface 461 can be attached to a surface of the support arm 531, with the first support surface 461 facing upwardly towards the source 300.

Referring to FIGS. 6 and 7, movement of the first jaw clamp 423 between the unclamped position and the clamped position is illustrated. In some embodiments, the first jaw clamp 423 may initially be in the unclamped position of FIG. 5. The unclamped position is illustrated with dashed lines in FIGS. 6 and 7 to represent a position of the attachment arm 515 and the first pad 511 when the attachment arm 515 is in the unclamped position. The rotational cylinder 517 can move the attachment arm 515 from the unclamped position to the clamped position. In some embodiments, the rotational cylinder 517 can impart rotational movement 701 to position the attachment arm 515 in an orientation for clamping and a clamping movement 703 to the attachment arm 515 to provide clamping of the glass ribbon between the pads 511, 513. As the attachment arm 515 moves towards the clamped position, the first pad 511 can move towards the glass ribbon 104. For example, in the unclamped position, the first pad 511 may be spaced apart from (e.g., not in contact with) the first major surface 215a of the glass ribbon 104. In the clamped position, the first pad 511 may be moved into contact with the first major surface 215a of the glass ribbon 104 such that the first pad 511 can be substantially aligned with the second pad 513. By being aligned, an axis may perpendicularly intersect the glass ribbon 104 while also intersecting the first pad 511 and the second pad 513.

It will be appreciated that when the first jaw clamp 423 is in the clamped position, the first pad 511 and the second pad 513 may apply a compressive force to the glass ribbon 104. This compressive force may be sufficient to hold the glass ribbon 104 by the first jaw clamp 423 and selectively impart movement to the glass ribbon 104. In some embodiments, this compressive force may likewise be sufficient to hold the glass ribbon 104 in place relative to the first jaw clamp 423, such that unintended movement of the glass ribbon 104 relative to the first jaw clamp 423 can be reduced.

While the foregoing description of the movement of a jaw clamp between the unclamped position and the clamped position was made relative to the first jaw clamp 423, it will be appreciated that the other jaw clamps (e.g., the second jaw clamp 425 and the third jaw clamp 427 of the first column of jaw clamps 409 and the first jaw clamp 429, the second jaw clamp 431, and the third jaw clamp 433 of the second column of jaw clamps 415) may function in a similar manner. For example, the second jaw clamp 425 and the third jaw clamp 427 of the first column of jaw clamps 409 and the first jaw clamp 429, the second jaw clamp 431, and the third jaw clamp 433 of the second column of jaw clamps 415) may similarly move from the unclamped position (e.g., illustrated with dashed lines) to the clamped position to provide additional clamping of the glass ribbon 104 at a plurality of locations along the lateral edges 153, 155 of the glass ribbon 104. The glass ribbon 104 may therefore be clamped at a plurality of locations by the first column of jaw clamps 409 and the second column of jaw clamps 415.

The use of pads, such as the first pad 511 and the second pad 513, may provide several benefits over other affixation structures, such as vacuum affixation, for example. In some embodiments, the first pad 511 and the second pad 513 may apply a compressive force to the first major surface 215a and the second major surface 215b, respectively. Due to the first pad 511 and the second pad 513 not being vacuum affixed to the glass ribbon 104, a gripping force may be increased as compared to a vacuum cup applying a vacuum affixation to one of the major surfaces 215a, 215b. In some embodiments, the first pad 511 and the second pad 513 may be less prone to slippage as compared to the vacuum cup affixation due to heat from the glass ribbon 104. In addition, the first pad 511 and the second pad 513 may experience extended life as compared to vacuum cup affixation, thus representing a cost savings.

Referring to FIG. 7, in some embodiments, the glass ribbon gripping device 400 can comprise one or more arms that facilitate movement of the first column of jaw clamps 409 and the second column of jaw clamps 415 relative to the frame 401. FIG. 7 illustrates an embodiment of the first jaw clamp 423 attached to the first protruding arm 501. In some embodiments, the second pad 513 and the rotational cylinder 517 can be attached to one or more adjustment arms, with the adjustment arms attached to the first protruding arm 501. For example, the adjustment arms may comprise a first adjustment arm 707 that can be attached to the first protruding arm 501 and a second adjustment arm 709 that may be attached to the first adjustment arm 707. In some embodiments, the second pad 513 and the rotational cylinder 517 can be attached to the second adjustment arm 709.

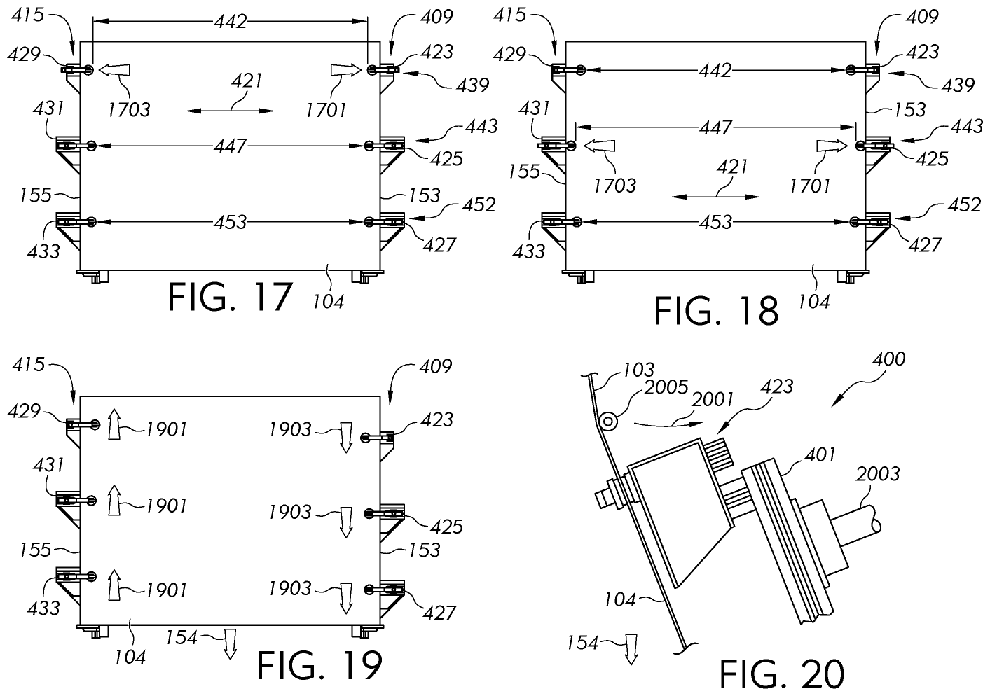

The first adjustment arm 707 can provide for lateral movement (e.g., into and out of the page in FIG. 7). For example, the first adjustment arm 707 may be movable (e.g., by a motor or other actuator) into and out of the page relative to the first protruding arm 501. Movement of the first adjustment arm 707 can cause lateral movement of the first jaw clamp 423 (e.g., into and out of the page in FIG. 7). The lateral movement of the jaw clamps can be further described and illustrated herein with respect to FIGS. 17 and 18. The second adjustment arm 709 can provide for vertical movement (e.g., up and down in FIG. 7). For example, the second adjustment arm 709 can be movable (e.g., by a motor or other actuator) up and down relative to the first adjustment arm 707. Movement of the second adjustment arm 709 can cause vertical movement of the first jaw clamp 423. The vertical movement of the jaw clamps can be further described and illustrated herein with respect to FIG. 19.

Referring to FIG. 8, rotational movement of the first support surface 461 along rotation direction 801 between an extended position and a retracted position is illustrated. In some embodiments, when the first support surface 461 is in the extended position (e.g., illustrated with dashed lines in FIG. 8 to represent a position of the first support surface 461 in the extended position), the first support surface 461 may lie within a plane defined by the glass ribbon 104, such that the plane defined by the glass ribbon 104 may intersect the first support surface 461 (e.g., also illustrated in FIG. 5 in which the glass ribbon 104 intersects the first support surface 461). In some embodiments, a lower edge 803 of the glass ribbon 104 can engage the first support surface 461, such as by contacting and/or resting upon the first support surface 461 as shown in FIG. 11.

The rotational arm 527 can rotate to cause the first support surface 461 to move along rotation direction 801 between the extended position (e.g., illustrated with dashed lines) and the retracted position (e.g., illustrated with solid lines). In some embodiments, movement of the first support surface 461 from the extended position towards the retracted position the rotational arm 527 can pivot about an axis in the rotation direction 801. As the rotational arm 527 pivots, the support arm 531 and the first support surface 461 can likewise pivot. The rotational arm 527 can continue to pivot at least until the first support surface 461 no longer lies within the plane defined by the glass ribbon 104. For example, in the retracted position, the glass ribbon 104 can be free to move downwardly along the glass ribbon travel direction 154 without the first support surface 461 engaging the lower edge 803 of the glass ribbon 104. While the retracted position of the first support surface 461 is illustrated as being about 180° offset from the first support surface 461 in the extended position, it will be appreciated that such a degree of offset is not intended to be limiting. Rather, in some embodiments, the rotational arm 527 may rotate the first support surface 461 to a position in which the first support surface 461 does not interfere with the movement of the glass ribbon 104, such as 90°, for example.

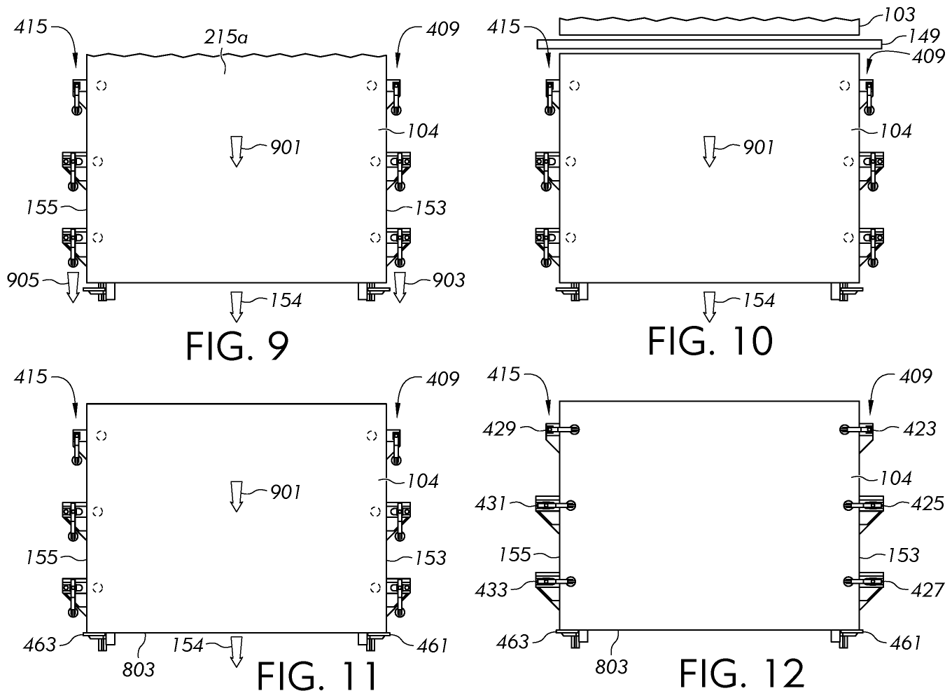

Referring to FIGS. 9-20, example embodiments of methods of manufacturing the glass ribbon 104 with the glass manufacturing apparatus 100 are illustrated. Referring to FIG. 9, methods of manufacturing the glass ribbon 104 can comprise moving the glass ribbon 104 along the glass ribbon travel direction 154, wherein the glass ribbon 104 can comprise the first major surface 215a (e.g., facing out of the page) and the second major surface 215b (e.g., facing into the page). In some embodiments, as the glass ribbon 104 moves 901 along the glass ribbon travel direction 154, methods of manufacturing the glass ribbon 104 comprise the first column of jaw clamps 409, the second column of jaw clamps 415, and the glass ribbon 104 moving 903, 905 together at the same velocity along the glass ribbon travel direction 154 prior to clamping the first lateral edge 153 of the glass ribbon 104 with the first column of jaw clamps 409 and prior to clamping the second lateral edge 155 of the glass ribbon 104 with the second column of jaw clamps 415. It will be appreciated that the movement of the glass ribbon 104, the first column of jaw clamps 409, and the second column of jaw clamps 415 is illustrated schematically with arrows 901, 903, 905. In some embodiments, the velocity of the first column of jaw clamps 409 and the second column of jaw clamps 415 may be the same as the velocity of the glass ribbon 104. In such an embodiment, the glass ribbon gripping device 400 can track the movement of the glass ribbon 104 as the glass ribbon 104 moves 901 along the glass ribbon travel direction 154.

In some embodiments, a portion of the glass ribbon 104 can be separated in any number of ways, such as with the glass separator 149 illustrated in FIG. 10. It will be appreciated that the glass separator 149 is illustrated schematically, as the glass separator 149 may represent several structures and/or operations that separate a portion of the glass ribbon 104 from the glass ribbon 104. Embodiments of the glass separator 149 may comprise, for example, one or more of a scribe, a score wheel, a diamond tip, a laser, etc.

In the illustrated embodiment, during the separation of the portion of the glass ribbon 104, the first column of jaw clamps 409 and the second column of jaw clamps 415 may be in the unclamped position. In the unclamped position, the first column of jaw clamps 409 and the second column of jaw clamps 415 may not grip and/or impart a force upon the glass ribbon 104. For example, the glass ribbon 104 may not be restrained by the glass ribbon gripping device 400 and, thus, the glass ribbon 104 may move 901 independently and relative to the first column of jaw clamps 409 and the second column of jaw clamps 415 along the glass ribbon travel direction 154.

Referring to FIG. 11, after the portion of the glass ribbon 104 has been separated by the glass separator 149, the separated portion of the glass ribbon 104 may move 901 by free falling, due to the force of gravity, along the glass ribbon travel direction 154. In some embodiments, methods of manufacturing the glass ribbon 104 can comprise engaging the lower edge 803 of the glass ribbon 104 prior to clamping the first lateral edge 153 and the second lateral edge 155 of the glass ribbon 104. In one embodiment, the first column of jaw clamps 409 and the second column of jaw clamps 415 may be held stationary and remain in the unclamped position. In another embodiment, the first column of jaw clamps 409 and the second column of jaw clamps 415 may move downwardly along the glass ribbon travel direction 154 at a velocity that may be less than the downward velocity at which the glass ribbon 104 moves 901 while free falling. In these embodiments, the lower edge 803 of the glass ribbon 104 can move into proximity with the first support surface 461 and the second support surface 463, with a distance between the lower edge 803 and the first support surface 461 and the second support surface 463 decreasing. As the glass ribbon 104 moves downwardly, the lower edge 803 of the glass ribbon 104 can be engaged prior to clamping the first lateral edge 153 and the second lateral edge 155 of the glass ribbon 104. For example, the lower edge 803 of the glass ribbon 104 can be engaged by the first support surface 461 and the second support surface 463. The lower edge 803 of the first lateral edge 153 can rest upon and/or be supported by the first support surface 461 while the lower edge 803 of the second lateral edge 155 can rest upon and/or be supported by the second support surface 463. In some embodiments, engaging prior to clamping the first lateral edge 153 and the second lateral edge 155 can help align the glass ribbon 104 relative to the glass ribbon gripping device 400. Indeed, in some embodiments, the engagement force may be less than the weight of the separated glass ribbon 104 and may be minimized or relatively low compared to the weight of the separated glass ribbon 104 to help prevent damage (e.g., by stress fracture) of the lower edge 803 of the glass ribbon 104. At the same time, the engagement force may be large enough to allow any misalignment of the separated glass ribbon 104 due to the separation process to be realigned with respect to the glass ribbon gripping device 400 such that the subsequent clamping of the first lateral edge 153 and the second lateral edge 155 of the glass ribbon can occur at the proper locations of the lateral edges 153, 155. Gripping at the proper locations of the lateral edges 153, 155 can help prevent surface damage to the pristine central portion 152 as well as minimize the amount of material to be removed, thereby maximizing the size of the pristine central portion 152.

Referring to FIG. 12, methods of manufacturing the glass ribbon 104 can comprise clamping the first lateral edge 153 of the glass ribbon 104 with the first column of jaw clamps 409 by engaging the first major surface 215a and the second major surface 215b with each jaw clamp 423, 425, 427 of the first column of jaw clamps 409. Methods of manufacturing the glass ribbon 104 may also comprise clamping the second lateral edge 155 of the glass ribbon 104 with the second column of jaw clamps 415 by engaging the first major surface 215a and the second major surface 215b with each jaw clamp 429, 431, 433 of the second column of jaw clamps 415. For example, after the lower edge 803 of the glass ribbon 104 has been engaged by the first support surface 461 and the second support surface 463, the glass ribbon 104 can be clamped by the jaw clamps. In some embodiments, the clamping of the first lateral edge 153 and the second lateral edge 155 can occur due to the first column of jaw clamps 409 and the second column of jaw clamps 415 moving from the unclamped position (e.g., illustrated in FIG. 11) to the clamped position (e.g., illustrated in FIG. 12). In the clamped position, the first column of jaw clamps 409 and the second column of jaw clamps 415 can grip the glass ribbon 104 (e.g., also illustrated in FIGS. 6 and 7), such that the glass ribbon 104 may be limited from moving independently of the first column of jaw clamps 409 and the second column of jaw clamps 415. With the first column of jaw clamps 409 and the second column of jaw clamps 415 in the clamped position, the glass ribbon gripping device 400 can move, guide, and/or direct the glass ribbon 104 to a desired location.

Throughout the disclosure, in the unclamped orientation as shown and discussed with respect to the dashed lines in FIG. 6, the attachment arm 515 and first pad 511 may be positioned away from and outside of the corresponding outer edge of the glass ribbon 104. In such a position, the attachment arm 515 and first pad 511 will not interfere with the glass ribbon 104 in case there is a disturbance in the glass ribbon. For instance, the glass ribbon 104 may be able to travel past the attachment arm 515 and first pad 511 (in a direction out of the page shown in FIG. 9) in instances where the glass ribbon is swaying back and forth relative to the root 145 of the forming wedge 209. In some embodiments, the second pads 513 may engage the second major surface 215b of the glass ribbon first to help stabilize the glass ribbon prior to clamping. Alternatively, the glass ribbon 104 can be stabilized for proper positioning relative to the glass ribbon gripping device 400. For instance, the swaying may stop or the amplitude of the swaying may be reduced to the point where the attachment arm 515 and first pad 511 will not interfere with the glass ribbon 104. At that point, as shown in FIG. 6-12, the attachment arms 515 and first pads 511 may all be rotated about direction 701 to the position shown in solid lines in FIGS. 6 and 7 and as further shown in FIG. 12. Then, jaw clamps may all undergo the clamping movement 703 described previously to pinch the corresponding first and second lateral edge 153, 155 with the jaw clamps.

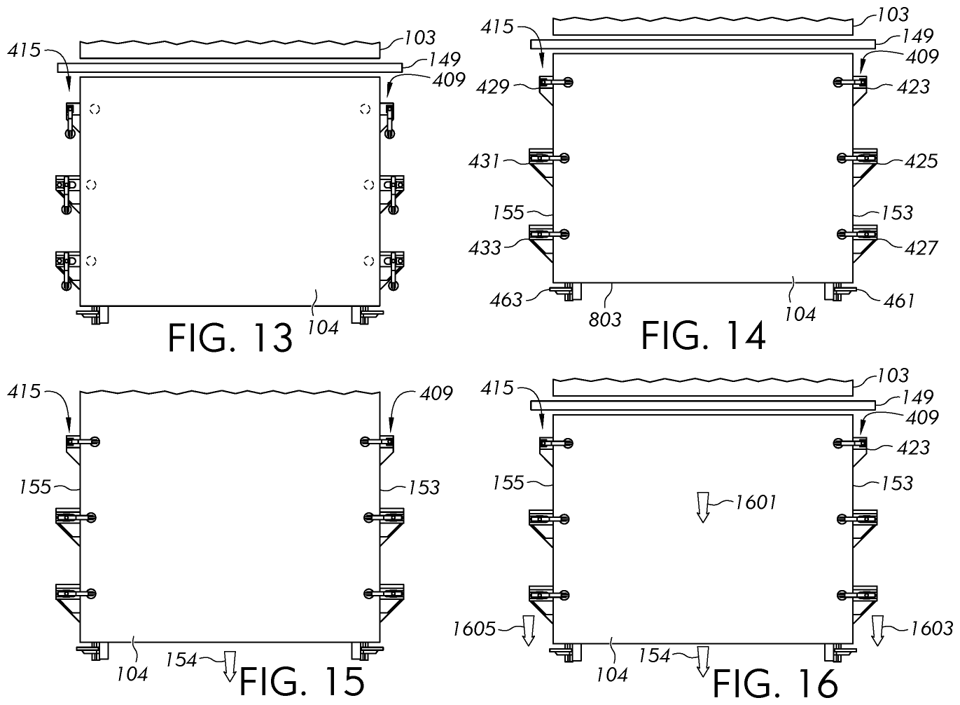

Referring to FIGS. 13 and 14, further example embodiments of methods of manufacturing the glass ribbon 104 with the glass manufacturing apparatus 100 are illustrated. In these embodiments, methods of manufacturing the glass ribbon 104 can comprise separating the glass ribbon 104 and catching the separated glass ribbon 104 with the clamping of the first lateral edge 153 and the second lateral edge 155 of the glass ribbon 104. As with the previous embodiment illustrated in FIGS. 9-12, the first column of jaw clamps 409 and the second column of jaw clamps 415 may initially be in the unclamped position after the glass ribbon 104 has been separated by the glass separator 149.

As illustrated in FIG. 14, after separation of the glass ribbon 104 by the glass separator 149, methods can comprise catching the separated glass ribbon 104 with the clamping of the first lateral edge 153 and the second lateral edge 155 of the glass ribbon 104. In some embodiments, this clamping may comprise clamping the first lateral edge 153 of the glass ribbon 104 with the first column of jaw clamps 409 by engaging the first major surface 215a and the second major surface 215b with each jaw clamp (e.g., the first jaw clamp 423, the second jaw clamp 425, and the third jaw clamp 427) of the first column of jaw clamps 409. This clamping may also comprise clamping the second lateral edge 155 of the glass ribbon 104 with the second column of jaw clamps 415 by engaging the first major surface 215a and the second major surface 215b with each jaw clamp (e.g., the first jaw clamp 429, the second jaw clamp 431, and the third jaw clamp 433) of the second column of jaw clamps 415.

In some embodiments, the step of catching the glass ribbon 104 with the first column of jaw clamps 409 and the second column of jaw clamps 415 may occur prior to the lower edge 803 of the glass ribbon 104 engaging the first support surface 461 and the second support surface 463. For example, as illustrated in FIG. 14, the lower edge 803 of the glass ribbon 104 may be spaced a distance apart from the first support surface 461 and the second support surface 463. In some embodiments, the step of catching the glass ribbon 104 may occur during or immediately after the separation of the glass ribbon 104 such that the glass ribbon 104 may not free fall or may free fall only a short distance prior to being caught by the first column of jaw clamps 409 and the second column of jaw clamps 415. In another embodiment, the step of catching the glass ribbon 104 may occur after the separation of the glass ribbon 104 such that the separated portion of glass ribbon 104 may fall a distance prior to being caught by the first column of jaw clamps 409 and the second column of jaw clamps 415 but before the lower edge 803 of the glass ribbon 104 engages the first support surface 461 and the second support surface 463.

In the embodiment of FIG. 14, the first support surface 461 and the second support surface 463 may optionally be in the extended position or the retracted position. For example, due to the first column of jaw clamps 409 and the second column of jaw clamps 415 engaging and clamping the first lateral edge 153 and the second lateral edge 155 of the glass ribbon 104, the glass ribbon 104 may be held by the first column of jaw clamps 409 and the second column of jaw clamps 415, such that engagement of the lower edge 803 of the glass ribbon 104 by the first support surface 461 and the second support surface 463 may not be necessary.

Referring to FIG. 15, further embodiments of methods of manufacturing the glass ribbon 104 with the glass ribbon manufacturing apparatus 100 are illustrated. In this embodiment, the glass ribbon 104 can be clamped with the first column of jaw clamps 409 and the second column of jaw clamps 415 in the clamped position prior to the separation of the glass ribbon 104 from the another portion of the glass ribbon 104. For example, the glass ribbon 104 can move along the glass ribbon travel direction 154. The first column of jaw clamps 409 and the second column of jaw clamps 415 can move from the unclamped position to the clamped position (e.g., as illustrated) to clamp the first lateral edge 153 and the second lateral edge 155. In some embodiments, methods of manufacturing the glass ribbon 104 comprise the first column of jaw clamps 409, the second column of jaw clamps 415, and the glass ribbon 104 moving together at the same velocity along the glass ribbon travel direction 154 after clamping the first lateral edge 153 of the glass ribbon 104 with the first column of jaw clamps 409 and the second lateral edge 155 of the glass ribbon 104 with the second column of jaw clamps 415 but before the separation of the glass ribbon 104 from the another portion of the glass ribbon 104 has occurred.

In some embodiments, the first column of jaw clamps 409 and the second column of jaw clamps 415 can move laterally as the glass ribbon 104 moves along the glass ribbon travel direction 154. For example, the glass ribbon 104 may experience some degree of lateral, side-to-side movement as the glass ribbon 104 moves downwardly along the glass ribbon travel direction 154. To accommodate for this lateral, side-to-side movement, the first column of jaw clamps 409 and the second column of jaw clamps 415 can likewise move laterally so as not to restrict movement of the glass ribbon 104 and/or apply unintended forces to the glass ribbon 104.

Referring to FIG. 16, the separation of the glass ribbon 104 from the another portion of the glass ribbon 104 is illustrated. In some embodiments, before, during, and after the separation, the glass ribbon 104 may be clamped by the first column of jaw clamps 409 and the second column of jaw clamps 415. In this embodiment, as the glass ribbon 104 moves 1601 along the glass ribbon travel direction 154, the first column of jaw clamps 409, the second column of jaw clamps 415, and the glass ribbon 104 can move 1603, 1605 together at the same velocity along the glass ribbon travel direction 154 after clamping the first lateral edge 153 of the glass ribbon 104 with the first column of jaw clamps 409 and the second lateral edge 155 of the glass ribbon 104 with the second column of jaw clamps 415 after the separation of the glass ribbon 104 from the another portion of the glass ribbon 104 has occurred.

Referring to FIG. 17, in some embodiments, the at least one jaw clamp 423, 425, 427 of the first column of jaw clamps 409 may be laterally adjustable in the lateral direction 421 relative to the at least one jaw clamp 429, 431, 433 of the second column of jaw clamps 415. For example, the first jaw clamp 423 may be laterally adjustable in a first lateral direction 1701. The first lateral direction 1701 can be oriented towards the first lateral edge 153 of the glass ribbon 104. The first jaw clamp 423 may be moved along the first lateral direction 1701 when the first jaw clamp 423 is in the clamped or unclamped position. When the first jaw clamps 423, 429 are in the clamped position, movement of the first jaw clamp 423 along the first lateral direction 1701 can cause the first jaw clamp 423 to move away from the first jaw clamp 429 of the second column of jaw clamps 415, thus increasing the tension of the glass ribbon 104. It will be appreciated that the first jaw clamp 423 may not be limited to moving in the first lateral direction 1701. Rather, in some embodiments, the first jaw clamp 423 can be moved in a second lateral direction 1703 that can be oriented towards the second lateral edge 155. When the first jaw clamps 423, 429 are in the clamped position, movement of the first jaw clamp 423 along the second lateral direction 1703 can cause the first jaw clamp 423 to move towards the first jaw clamp 429 of the second column of jaw clamps 415, thus decreasing the tension of the glass ribbon 104.

In some embodiments, the first jaw clamp 429 of the second column of jaw clamps 415 may be laterally adjustable in the first lateral direction 1701 or the second lateral direction 1703 (e.g., as illustrated). The first jaw clamp 429 may be moved along the second lateral direction 1703 when the first jaw clamp 429 is in the clamped or unclamped position. When the first jaw clamps 423, 429 are in the clamped position, movement of the first jaw clamp 429 along the second lateral direction 1703 can cause the first jaw clamp 429 to move away from the first jaw clamp 423 of the first column of jaw clamps 409, thus increasing the tension of the glass ribbon 104. It will be appreciated that the first jaw clamp 429 may not be limited to moving in the second lateral direction 1703. Rather, in some embodiments, the first jaw clamp 429 can be moved in the first lateral direction 1701 that can be oriented towards the first lateral edge 153. When the first jaw clamps 423, 429 are in the clamped position, movement of the first jaw clamp 429 along the first lateral direction 1701 can cause the first jaw clamp 429 to move towards the first jaw clamp 423 of the first column of jaw clamps 409, thus decreasing the tension of the glass ribbon 104.

In these embodiments, at least one jaw clamp of the first column of jaw clamps 409 may be laterally adjustable in the lateral direction 421 relative to at least one jaw clamp of the second column of jaw clamps 415. For example, methods of manufacturing the glass ribbon 104 comprise adjusting the first lateral spacing 442 between the first jaw clamp 423 of the first column of jaw clamps 409 and the first jaw clamp 429 of the second column of jaw clamps 415 to adjust a first lateral tension of the glass ribbon 104 at the first elevation 441. For example, the first jaw clamp 423 of the first column of jaw clamps 409 may be moved in the first lateral direction 1701 or the second lateral direction 1703 independent of the first jaw clamp 429 of the second column of jaw clamps 415. In some embodiments, the first jaw clamp 429 of the second column of jaw clamps 415 may be moved in the first lateral direction 1701 or the second lateral direction 1703 independent of the first jaw clamp 423 of the first column of jaw clamps 409. In these embodiments, the first lateral spacing 442 between the jaw clamps 423, 429 of the first elevational pair 439 of jaw clamps may be adjustable in the lateral direction 421.

In some embodiments, the first lateral spacing 442 between the jaw clamps 423, 429 of the first elevational pair 439 of jaw clamps may be adjustable in the lateral direction 421 independent of the second lateral spacing 447 between the jaw clamps 425, 431 of the second elevational pair 443 of jaw clamps. Likewise, in some embodiments, the first lateral spacing 442 between the jaw clamps 423, 429 of the first elevational pair 439 may be adjustable in the lateral direction 421 independent of the third lateral spacing 453 between the jaw clamps 427, 433 of the third elevational pair 452 of jaw clamps. In some embodiments, the first jaw clamp 423 of the first column of jaw clamps 409 may be laterally adjustable independent of the other jaw clamps (e.g., 425, 427, 429, 431, 433), while the first jaw clamp 429 of the second column of jaw clamps 415 may be laterally adjustable independent of the other jaw clamps (e.g., 423, 425, 427, 431, 433).

The first lateral spacing 442 may therefore be adjustable while the second lateral spacing 447 and/or the third lateral spacing 453 can remain unchanged. In some embodiments, the adjusting the first lateral spacing 442 may be conducted independent of the second lateral spacing 447 between the second jaw clamp 425 of the first column of jaw clamps 409 and the second jaw clamp 431 of the second column of jaw clamps 415 at the second elevation 445 of the glass ribbon 104. By adjusting the first lateral spacing 442, a first lateral tension of the glass ribbon 104 may be adjusted such that the adjusted first lateral tension of the glass ribbon 104 at the first elevation 441 may be different than a second lateral tension of the glass ribbon 104 at the second elevation 445 of the glass ribbon 104 and/or a third lateral tension of the glass ribbon 104 at the third elevation 451 of the glass ribbon 104. In some embodiments, the first lateral spacing 442 may be greater than, less than, or equal to the second lateral spacing 447 and the third lateral spacing 453.

Referring to FIG. 18, in some embodiments, the second lateral spacing 447 between the jaw clamps 425, 431 of the second elevational pair 443 of jaw clamps may be adjustable in the lateral direction 421. As with the embodiment illustrated and described with respect to FIG. 17, the second jaw clamp 425 of the first column of jaw clamps 409 and the second jaw clamp 431 of the second column of jaw clamps 415 may be laterally adjustable in the first lateral direction 1701 or the second lateral direction 1703. In some embodiments, the second jaw clamp 425 of the first column of jaw clamps 409 may be laterally adjustable independent of the other jaw clamps (e.g., 423, 427, 429, 431, 433). In some embodiments, the second jaw clamp 431 of the second column of jaw clamps 415 may be laterally adjustable independent of the other jaw clamps (e.g., 423, 425, 427, 429, 433). The second lateral spacing 447 between the jaw clamps 425, 431 of the second elevational pair 443 of jaw clamps may be adjustable in the lateral direction 421 independent of the first lateral spacing 442 between the jaw clamps 423, 429 of the first elevational pair 439 of jaw clamps.

In some embodiments, methods of manufacturing the glass ribbon 104 comprise adjusting the second lateral spacing 447 between the second jaw clamp 425 of the first column of jaw clamps 409 and the second jaw clamp 431 of the second column of jaw clamps 415 to adjust a second lateral tension at the second elevation 445 of the glass ribbon 104. In some embodiments, due to the second jaw clamps 425, 431 being laterally adjustable independent of the other jaw clamps (e.g., 423, 427, 429, 433), the second lateral tension may be adjusted independent of adjusting the first lateral tension. In some embodiments, the first lateral spacing 442 and the second lateral spacing 447 may be adjusted, with the first lateral spacing 442 (and, thus, adjusted first lateral tension) being different than the second lateral spacing 447 (and, thus, adjusted second lateral tension). In this embodiment, by adjusting the first lateral spacing 442 and the second lateral spacing 447 to be different, methods of manufacturing the glass ribbon 104 comprise the adjusted first lateral tension of the glass ribbon 104 being different than the adjusted second lateral tension of the glass ribbon 104. In some embodiments, the second lateral spacing 447 may be greater than, less than, or equal to the first lateral spacing 442 and/or the third lateral spacing 453.

It will be appreciated that in further embodiments, the third lateral spacing 453 between the third jaw clamp 427 of the first column of jaw clamps 409 and the third jaw clamp 433 of the second column of jaw clamps 415 may be adjusted in a similar manner as the first lateral spacing 442 and the second lateral spacing 447. For example, the third jaw clamp 427 of the first column of jaw clamps 409 and the third jaw clamp 433 of the second column of jaw clamps 415 may each be laterally adjustable in the first lateral direction 1701 or the second lateral direction 1703. The third jaw clamp 427 of the first column of jaw clamps 409 and the third jaw clamp 433 of the second column of jaw clamps 415 may each be laterally adjusted independent of the other jaw clamps (e.g., 423, 425, 429, 431). In some embodiments, the third lateral spacing 453 may be greater than, less than, or equal to the first lateral spacing 442 and the second lateral spacing 447.

Referring to FIG. 19, in some embodiments, the at least one jaw clamp 423, 425, 427 of the first column of jaw clamps 409 can be vertically adjustable in the glass ribbon travel direction 154 relative to the at least one jaw clamp 429, 431, 433 of the second column of jaw clamps 415. In some embodiments, the first jaw clamp 423, the second jaw clamp 425, and/or the third jaw clamp 427 may be moved along a first vertical direction 1901 or a second vertical direction 1903 when the first jaw clamp 423, the second jaw clamp 425, and the third jaw clamp 427 are in the clamped or unclamped position. The first vertical direction 1901 may be oriented towards a top edge of the glass ribbon 104 while the second vertical direction 1903 may be oriented towards a bottom edge of the glass ribbon 104. In some embodiments, one or more of the jaw clamps may be vertically adjustable, such as the first jaw clamp 423 being vertically adjustable independent of the other jaw clamps (e.g., 425, 427, 429, 431, 433).

In some embodiments, the at least one jaw clamp 429, 431, 433 of the second column of jaw clamps 415 may be vertically adjustable in the glass ribbon travel direction 154 relative to the at least one jaw clamp 423, 425, 427 of the first column of jaw clamps 409. In some embodiments, the first jaw clamp 429, the second jaw clamp 431, and/or the third jaw clamp 433 may be moved along the first vertical direction 1901 or the second vertical direction 1903 when the first jaw clamp 429, the second jaw clamp 431, and the third jaw clamp 433 are in the clamped or unclamped position. In some embodiments, one or more of the jaw clamps may be vertically adjustable, such as the first jaw clamp 429 being vertically adjustable independent of the other jaw clamps (e.g., 423, 425, 427, 431, 433).

By providing for an adjustable lateral spacing between the at least one jaw clamp 423, 425, 427 of the first column of jaw clamps 409 and the at least one jaw clamp 429, 431, 433 of the second column of jaw clamps 415, a tension of the glass ribbon 104 along the lateral direction 421 can be adjusted. For example, a tension of the glass ribbon 104 can be adjusted at a plurality of locations along the glass ribbon 104 by adjusting the lateral spacing between the jaw clamps. In some embodiments, the vertical adjustability of the jaw clamps 423, 425, 427, 429, 431, 433 can increase or decrease the speed at which the glass ribbon 104 moves along the glass ribbon travel direction 154. The vertical adjustability can also allow for a tension of the glass ribbon 104 along the glass ribbon travel direction 154 to be adjusted.

Referring to FIG. 20, a side view of the first jaw clamp 423 of the glass ribbon gripping device 400 is illustrated. In some embodiments, the glass ribbon gripping device 400 may not be limited to applying force to the glass ribbon 104 along the glass ribbon travel direction 154 or the lateral direction 421. Rather, in some embodiments, the glass ribbon gripping device 400 can apply a force to the glass ribbon 104 along a bending direction 2001 that can be perpendicular to the glass ribbon travel direction 154 and the lateral direction 421. For example, a machine 2003 can engage the frame 401, such as by being attached to a rear side of the frame 401 opposite the glass ribbon 104. The machine 2003 can be configured to move the frame 401 along the bending direction 2001. In some embodiments, the glass ribbon 104 can extend adjacent to a nosing 2005 at a location upstream (e.g., above) the glass ribbon gripping device 400. With the jaw clamps 423, 425, 427, 429, 431, 433 in the clamped position, the machine 2003 may rotate the frame 401 along the bending direction 2001. As the frame 401 moves along the bending direction 2001, the glass ribbon 104 can engage the nosing 2005, thus causing the glass ribbon 104 to separate from another portion of the glass ribbon 104 (e.g., upstream from the glass ribbon 104).

In some embodiments of the disclosure, the glass ribbon gripping device 400 can provide for reduced wear of the jaw clamps 423, 425, 427, 429, 431, 433 that are in contact with the glass ribbon 104. For example, due to the potentially high temperatures (e.g., 300° Celsius and higher) that the glass ribbon gripping device 400 may be exposed to, the jaw clamps 423, 425, 427, 429, 431, 433 can apply a compressive gripping force when in the clamped position. This compressive gripping force may be higher than achieved in the past with vacuum cup affixation, thus reducing the likelihood of slippage of the glass ribbon 104. In the event of the jaw clamps 423, 425, 427, 429, 431, 433 exhibiting wear due to heat, a gripping force of the jaw clamps 423, 425, 427, 429, 431, 433 can be increased to limit slippage of the glass ribbon 104. Further, the jaw clamps 423, 425, 427, 429, 431, 433 may not experience vacuum leaks or vacuum failure that may be common due to tearing or cutting of vacuum cups.

In some embodiments, the glass ribbon gripping device 400 can provide for reduced motion and pull-force on the glass ribbon 104 during the scoring and separation process. For example, as illustrated in FIGS. 9-11, the jaw clamps 423, 425, 427, 429, 431, 433 may be in the unclamped position when the glass ribbon 104 is separated by the glass separator 149. By being in the unclamped position, the jaw clamps 423, 425, 427, 429, 431, 433 may not impart motion or pull-force on the glass ribbon 104, such that the glass ribbon 104 can move independently of the jaw clamps 423, 425, 427, 429, 431, 433. After the glass ribbon 104 has been separated, the separated portion of the glass ribbon 104 may engage and rest upon the first support surface 461 and the second support surface 463 prior to the jaw clamps 423, 425, 427, 429, 431, 433 clamping the glass ribbon 104. By not contacting the glass ribbon 104 until after the separation has been completed, improved alignment and stability of the glass ribbon 104 can be achieved.

What is claimed is:

1. A glass manufacturing apparatus comprising:
a glass ribbon gripping device comprising a first column of jaw clamps spaced from one another along a first clamp path extending in a glass ribbon travel direction of the glass manufacturing apparatus, a second column of jaw clamps spaced from one another along a second clamp path extending in the glass ribbon travel direction of the glass manufacturing apparatus, and the first column of jaw clamps and the second column of jaw clamps are spaced apart in a lateral direction perpendicular to the glass ribbon travel direction.

2. The glass manufacturing apparatus of claim 1, further comprising a support surface positioned below at least one of the first column of jaw clamps and the second column of jaw clamps, the support surface extending at least partially across a travel path of the glass ribbon.

3. The glass manufacturing apparatus of claim 1, wherein at least one jaw clamp of the first column of jaw clamps is laterally adjustable in the lateral direction relative to at least one jaw clamp of the second column of jaw clamps.

4. The glass manufacturing apparatus of claim 1, wherein at least one jaw clamp of the first column of jaw clamps is vertically adjustable in the glass ribbon travel direction relative to at least one jaw clamp of the second column of jaw clamps.

5. The glass manufacturing apparatus of claim 1, wherein at least one jaw clamp of the second column of jaw clamps is vertically adjustable in the glass ribbon travel direction relative to at least one jaw clamp of the first column of jaw clamps.

6. The glass manufacturing apparatus of claim 1, wherein a first jaw clamp of the first column of j aw clamps and a first jaw clamp of the second column of jaw clamps forms a first elevational pair of jaw clamps positioned at a first elevation, a second jaw clamp of the first column of j aw clamps and a second jaw clamp of the second column of jaw clamps forms a second elevational pair of jaw clamps positioned at a second elevation.

7. The glass manufacturing apparatus of claim 6, wherein a first lateral spacing between the jaw clamps of the first elevational pair of jaw clamps is adjustable in the lateral direction.

8. The glass manufacturing apparatus of claim 7, wherein the first lateral spacing between the jaw clamps of the first elevational pair of jaw clamps is adjustable in the lateral direction independent of a second lateral spacing between the jaw clamps of the second elevational pair of jaw clamps.

9. The glass manufacturing apparatus of claim 6, wherein a second lateral spacing between the jaw clamps of the second elevational pair of jaw clamps is adjustable in the lateral direction.

10. The glass manufacturing apparatus of claim 9, wherein the second lateral spacing between the jaw clamps of the second elevational pair of jaw clamps is adjustable in the lateral direction independent of a first lateral spacing between the jaw clamps of the first elevational pair of jaw clamps.

11. A method of manufacturing a glass ribbon with the glass manufacturing apparatus of claim 1 comprising the steps of:
moving the glass ribbon along the glass ribbon travel direction, the glass ribbon comprising a first major surface and a second major surface;
clamping a first lateral edge of the glass ribbon with the first column of jaw clamps by engaging the first major surface and the second major surface with each jaw clamp of the first column of jaw clamps; and
clamping a second lateral edge of the glass ribbon with the second column of jaw clamps by engaging the first major surface and the second major surface with each jaw clamp of the second column of jaw clamps.

12. The method of claim 11, further comprising separating the glass ribbon from another portion of the glass ribbon and catching the separated glass ribbon with the clamping of the first lateral edge and the second lateral edge of the glass ribbon.

13. The method of claim 11, further comprising engaging a lower edge of the glass ribbon prior to clamping the first lateral edge and the second lateral edge of the glass ribbon.

14. The method of claim 11, further comprising adjusting a first lateral spacing between a first jaw clamp of the first column of jaw clamps and a first jaw clamp of the second column of jaw clamps to adjust a first lateral tension of the glass ribbon at a first elevation.

15. The method of claim 14, wherein adjusting the first lateral spacing is conducted independent of a second lateral spacing between a second jaw clamp of the first column of jaw clamps and a second jaw clamp of the second column of jaw clamps at a second elevation of the glass ribbon.

16. The method of claim 15, wherein the adjusted first lateral tension of the glass ribbon at the first elevation is different than a second lateral tension of the glass ribbon at the second elevation of the glass ribbon.

17. The method of claim 11, further comprising adjusting a second lateral spacing between a second jaw clamp of the first column of jaw clamps and a second jaw clamp of the second column of jaw clamps to adjust a second lateral tension at a second elevation of the glass ribbon.

18. The method of claim 17, wherein adjusting the second lateral tension is conducted independent of adjusting the first lateral tension.

19. The method of claim 17, wherein the adjusted first lateral tension is different than the adjusted second lateral tension.

20. The method of claim 11, wherein the first column of jaw clamps, the second column of jaw clamps, and the glass ribbon move together at the same velocity along the glass ribbon travel direction prior to clamping the first lateral edge of the glass ribbon with the first column of jaw clamps and prior to clamping a second lateral edge of the glass ribbon with the second column of jaw clamps.

21. The method of claim 11, wherein the first column of jaw clamps, the second column of jaw clamps, and the glass ribbon move together at the same velocity along the glass ribbon travel direction after clamping the first lateral edge of the glass ribbon with the first column of jaw clamps and after clamping a second lateral edge of the glass ribbon with the second column of jaw clamps.
